(19) United States
(12) Patent Application Publication
(10) Pub. No.: US 2008/0150453 A1
(43) Pub. Date: Jun. 26, 2008

(54) CANDLE EMULATION DEVICE WITH AEROSOL-BASED FRAGRANCE RELEASE MECHANISM

(75) Inventors: Mark Medley, Covina, CA (US); Michael Boone, Los Angeles, CA (US); Kurt Campbell, Cupertino, CA (US); David Zito, Pasadena, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: ENCHANTED LIGHTING COMPANY, LLC, Azusa, CA (US)

(21) Appl. No.: 12/043,035

(22) Filed: Mar. 5, 2008

Related U.S. Application Data
(63) Continuation-in-part of application No. 11/633,084, filed on Dec. 1, 2006.
Application No. 11/633,084 is a continuation-in-part of application No. 11/294,930, filed on Dec. 6, 2005.

(51) Int. Cl. F21V 21/00; H05B 37/00; F21V 35/00

(52) U.S. Cl. 315/312; 362/249; 362/392

(57) ABSTRACT

According to one embodiment of the invention, a candle emulation device comprises a light source, a light source controller and an aerosol-based fragrance-release mechanism. The light source controller is coupled to the light source and is adapted to control the light source in order to produce a lighting effect that emulates lighting from a candle flame. The aerosol-based fragrance-release mechanism is adapted to release a fragrance into the air surrounding the candle emulation device.

### CROSS-REFERENCES TO RELATED APPLICATIONS

This application is a continuation-in-part and claims the benefit of priority on U.S. patent application Ser. No. 11/633,084 filed Dec. 1, 2006, which is a continuation-in-part of U.S. patent application Ser. No. 11/294,930 filed Dec. 6, 2005.

### FIELD

Embodiments of the invention relate to the field of lighting, in particular, to candle emulation.

### GENERAL BACKGROUND

For centuries, wax candles have been used to provide lighting for all types of dwellings. Over the last thirty years, however, wax candles have mainly been used as decorative lighting or as subdued lighting for mood-setting purposes. For instance, restaurants use wax candles as decorations in order to provide a more intimate setting for their patrons. Individuals purchase wax candles for placement around their home to provide a festive or relaxing environment for their guests.

There are a few disadvantages with wax candles. One disadvantage is that they are costly to use when considering operational costs ($/usage time). In addition to their high cost, wax candles with open flames pose a risk of fire when left unattended for a period of time. These candles also pose a risk of harm to small children who do not understand the dangers of fire.

Accordingly, for cost savings and safety concerns, in certain situations, it would be beneficial to substitute a wax candle for a candle emulation device. Unfortunately, most conventional candle emulation devices do not accurately imitate the lighting effect of a flickering candle, namely a realistic flickering light pattern. For usage by restaurants, this may leave an unfavorable impression by patrons of a restaurant. For usage at home, it may not provide the overall mood-setting effect that the user has tried to create.

Also, neither wax candles nor conventional candle emulation devices provide fragrance-release mechanisms with replaceable cartridges or aerosol canisters with scented materials. These cartridges and canisters enable continuous fragrances to be released and enable different aromatic fragrances to be provided by the same product at different times.

### BRIEF DESCRIPTION OF THE DRAWINGS

The invention may best be understood by referring to the following description and accompanying drawings that are used to illustrate embodiments of the invention.

FIG. 1A is an exemplary block diagram of a candle emulation device employing the present invention.

FIGS. 1B-1D are exemplary embodiments of the fragrance-release mechanism of FIG. 1A.

FIG. 2A is a first exemplary embodiment of the candle emulation device of FIG. 1A.

FIG. 2B is a second exemplary embodiment of the candle emulation device of FIG. 1A.

FIG. 2C is a third exemplary embodiment of the candle emulation device of FIG. 1A.

FIG. 2D is a fourth exemplary embodiment of the candle emulation device of FIG. 1A.

FIGS. 2E-2G are a fifth exemplary embodiment of the candle emulation device of FIG. 1A.

FIG. 3 is an exemplary embodiment of an alternative light source for the candle emulation device of FIG. 1A.

FIG. 4 is an alternative embodiment of a light source placed within the candle emulation device of FIGS. 2E and 3

FIGS. 5-7 illustrate a seventh exemplary embodiment of the candle emulation device of FIG. 1A featuring a bottom-loading removable aerosol canister.

FIGS. 8-10 illustrate an eighth exemplary embodiment of the candle emulation device of FIG. 1A featuring a top-loading removable aerosol canister.

### DETAILED DESCRIPTION

Herein, certain embodiments of the invention relate to an apparatus, logic and method for electrically emulating lighting from a candle frame and for providing fragrance, most notably through an aerosol canister.

Herein, certain details are set forth below in order to provide a thorough understanding of various embodiments of the invention, albeit the invention may be practiced through many embodiments other than those illustrated. Well-known components and operations are not set forth in detail in order to avoid unnecessarily obscuring this description.

In the following description, certain terminology is used to describe features of the invention. For example, the term “lighting fixture” is generally defined as any device that provides illumination based on electrical input power, where as described below, a “candle emulation device” is merely a lighting fixture providing illumination that emulates the lighting effect of a candle. Examples of various types of lighting fixtures include, but are not limited or restricted to a lamp, a table lamp having the aesthetic appearance of a wax candle featuring a pillar or tapered candle housing, a sconce, chandelier, lantern, a night light or the like. Each candle emulation device includes one or more light sources which may include, but are not limited or restricted to incandescent light bulbs, light emitting diodes (LEDs) and the like. These lighting fixtures may operate as candle emulation devices as described below.

Both terms “component” and “logic” are generally defined as hardware and/or software, which may be adapted to perform one or more operations on an incoming signal. Examples of types of incoming signals include, but are not limited or restricted to power waveforms, clock, pulses, or other types of signaling. Also, the term “translucent material” is generally defined as any composition that permits the passage of light. Most types of translucent material diffuse light. However, some types of translucent material may be transparent in nature.

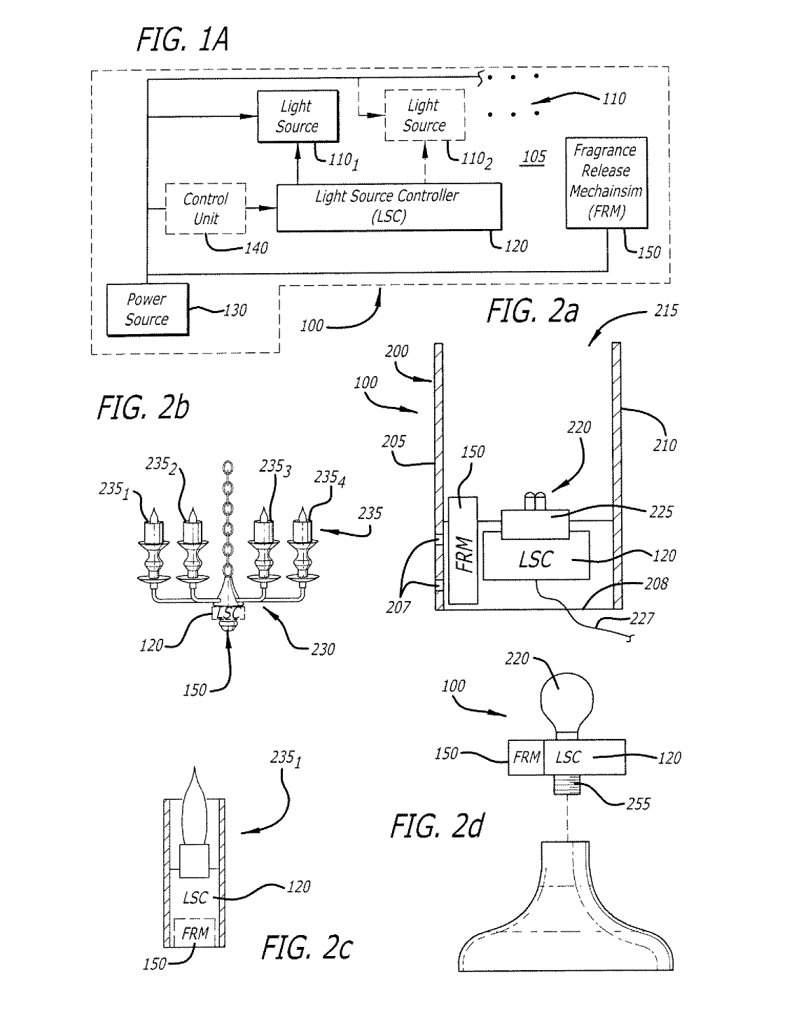

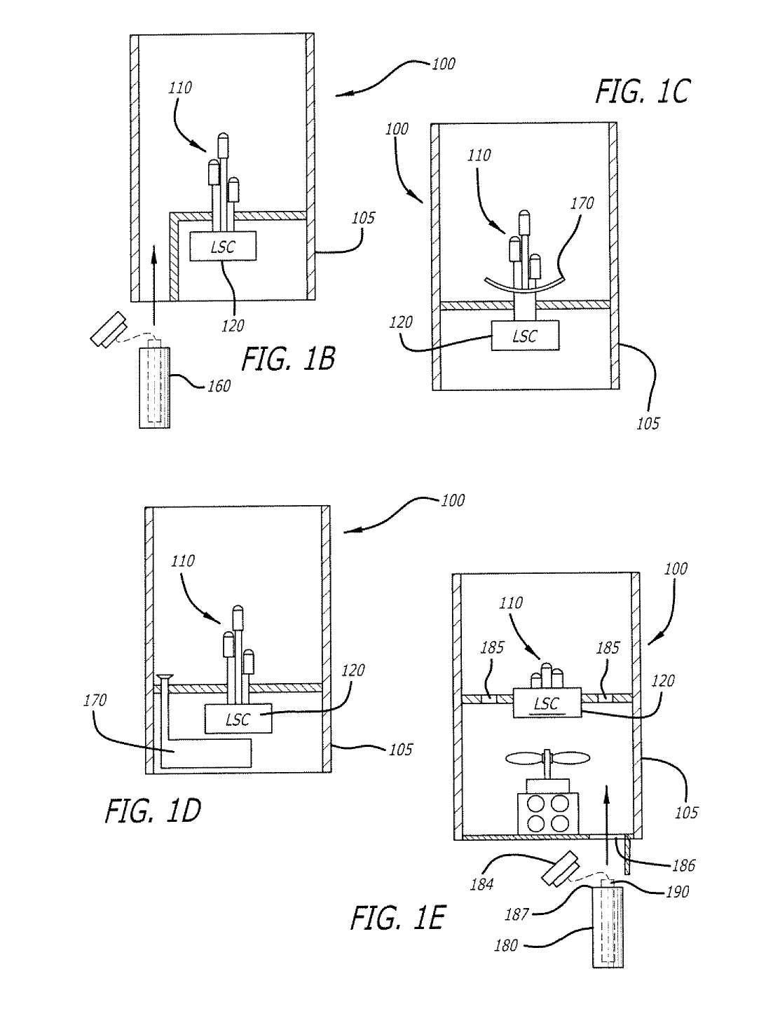

Referring to FIG. 1A, an exemplary block diagram of a candle emulation device employing the present invention is illustrated. Candle emulation device 100 comprises one or more light sources 110₁, . . . , and/or 110_{N} (N≧1), generally referred to as “light source 110,” controlled by a light source controller (LSC) 120 positioned within a housing 105. According to one embodiment of the invention, each light source 110 is one or more LEDs that may be electrically coupled to light source controller 120.

Light source 110 and light source controller 120 are supplied power by a power source 130, such as one or more batteries or any type of rechargeable power source for example. Of course, power source 120 may constitute line voltage (e.g., ranging between approximately 110-220 volts in accordance with U.S. and International power standards, such as 110 voltage alternating current “VAC” at 50 or 60 Hertz “Hz”, 220 VAC at 50 or 60 Hz, etc.) supplied from a connection to a power line or supplied from a wall socket when candle emulation device 100 is implemented as a plug-in device. Although not shown, the line voltage may be converted to an acceptable voltage level for use. Alternatively, power source 130 may be any number of other power supplying mechanisms such as a transformer that supplies low voltage power (12 VAC) for example. As illustrated, power source 130 may be situated internally within housing 105 of candle emulation device 100 or, in certain embodiments, may be placed external to housing 105.

Although not shown in FIG. 1A, according to one embodiment of the invention, light source controller 120 comprises a circuit board featuring power regulation and conditioning logic, candle emulation control logic and driver logic. The power regulation and conditioning logic is configured to provide regulated, local power in the event that unregulated input power is supplied by power source 130. The regulated local power is supplied to other components within light source controller 120. These components are adapted to create a realistic candle lighting pattern and to drive (activate/deactivate) light source 110.

Alternatively, it is contemplated that light source controller 120 may comprise multiple circuit boards with a primary circuit board adapted for power regulation and supplying regulated power to one or more secondary circuit boards responsible for controlling light source 110. As one example, a secondary circuit board may be adapted to control a single light source 110₁ or multiple light sources 110₁ and 110₂. As another example, one secondary circuit board may be adapted to control a light source 110₁ while another secondary circuit board may be adapted to control a different light source 110₂, and the like.

It is contemplated that light source controller 120 may be adapted with a first connector component designed so that light source 110 may be removed and replaced with a different light source. Similarly, light source controller 120 may be adapted with a second connector component designed so that either light source controller 120 or power source 130 may be removed and replaced as needed.

It is further contemplated that a control unit 140, optionally shown by dashed lines, may be adapted to cooperate with light source controller 120 to control the illumination of candle emulation device 100 of FIG. 1A. For instance, control unit 140 may be adapted as a power switch 140 situated within housing 105 or external to housing 105. It is contemplated, however, that control unit 140 may be a dimmer switch, a photocell, a timer or any unit for controlling an illumination output of light source 110.

As shown, a fragrance-release mechanism 150 may be implemented within housing 105. Fragrance-release mechanism (FRM) 150 comprises a scented material (e.g., material in a liquid, gaseous or solid form where particles of the material having a fragrance are emitted). According to one embodiment of the invention, such emissions may be caused by the movement of air over the scented material and through one or more openings in housing 105 of candle emulation device 100. The moving air carries fragrance particles. Of course, it is contemplated that the movement of air may be magnified through forced ventilation (e.g., use of fan) or by use of heat. According to another embodiment of the invention, such emissions may be caused by the release of aerosolized particles with fragrance from an aerosol canister and through one or more openings in housing 105 of candle emulation device 100 as described below.

According to one embodiment of the invention, as shown in FIG. 1B, the fragrance-release mechanism for candle emulation device 100 is implemented as a cartridge 160 that is filled with a liquid (e.g., aqueous-based solution, scented oil or other scented solution, etc.). According to one embodiment of the invention, cartridge 160 includes an open end (or partially covered end) that allows fragrance to be emitted in a gaseous form.

Alternatively, it is contemplated that cartridge 160 may include (1) a wick being material that is positioned so that one end is immersed in the liquid while the other end protrudes from an end of cartridge 160 as shown. The material forming the wick is a liquid absorbent material so that it absorbs the liquid so that the liquid within the material is exposed outside cartridge 160. This enables fragrance from the liquid to be released into the air. According to another alternative embodiment, cartridge 160 may include a gas permeable cover (not shown) that covers an open end of cartridge 160 but allows fragrance to be emitted in a gaseous form.

Cartridge 160 is inserted within housing 105 and maintained therein. Cartridge 160 may be permanently installed or may be removable to receive replacement cartridges as needed. As an optional feature, the liquid can be heated to accelerate the emission of the fragrance by increasing the rate of discharge of fragrance particles in gaseous form.

According to yet another embodiment of the invention, the fragrance-release mechanism may be a solid, scented material that is placed within housing 105 (not shown). The gaseous emission of the fragrance is conducted under ambient temperatures, where degradation of the scented material and emission of the fragrance may occur more slowly than when the scented material is in a liquid form. Of course, the solid scented material might be heated and placed into a liquid form to accelerate emission of the fragrance. The solid insert may be permanently installed within housing 105 or in a replaceable form factor.

As another alternative embodiment, as shown in FIGS. 1C-1D, the fragrance-release mechanism is scented material that is placed into a storage device 170 within housing 105. Storage device 170 may be adapted to retain the scented material in a liquid form. The liquid is poured into storage device 170 and exposed to the air, where gaseous emissions of the fragrance occur under ambient temperatures. Where the scented material is a solid, the solid is placed in storage device 170 and exposed to air. Examples of storage device 170 include, but are not limited or restricted to a tray positioned above light source controller 120 as shown in FIG. 1C or a container with an opening as shown in FIG. 1D. Of course, the scented material may be heated to accelerate emissions of the fragrance. Such heating may be accomplished by the light source or by a separate heating unit.

As yet another alternative embodiment, as shown in FIG. 1E, the fragrance-release mechanism may be implemented as scented material having a fragrance that is loaded into a cartridge 180. Cartridge 180 is inserted into housing 105 through an opening 186 positioned at a bottom surface 188 of housing 105. Cartridge 180 may be adapted to retain the scented material in a liquid form, but gaseous emissions of the fragrance are produced from controlled evaporation of the liquid under ambient or higher temperatures and escape through openings 185. Examples of cartridge 180 include, but are not limited or restricted to a bottle 182 with a removable top cover 184 that is removed prior to installation into housing 105 as shown. To minimize spillage of the scented liquid, a wick 190 may be placed within bottle 182 and extends from an open-end 183 of bottle 182 that was previously covered by cover 184.

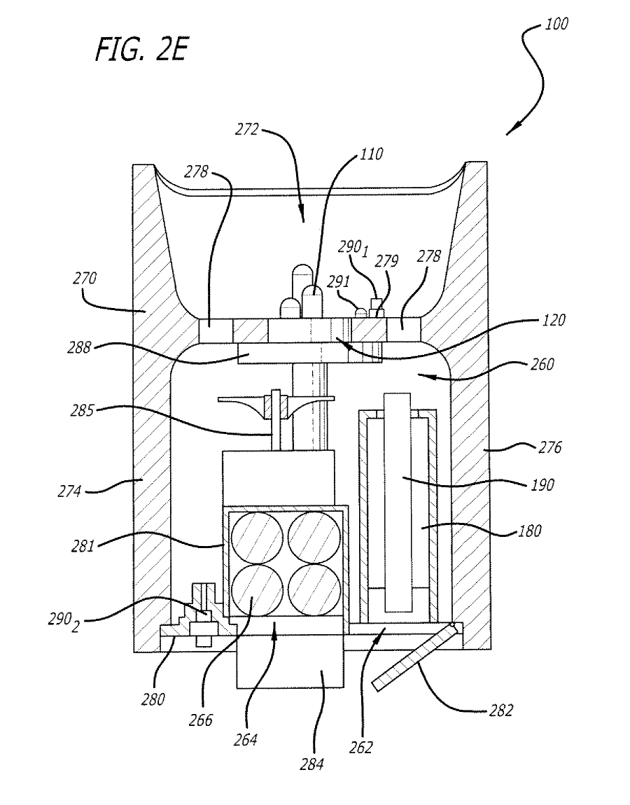

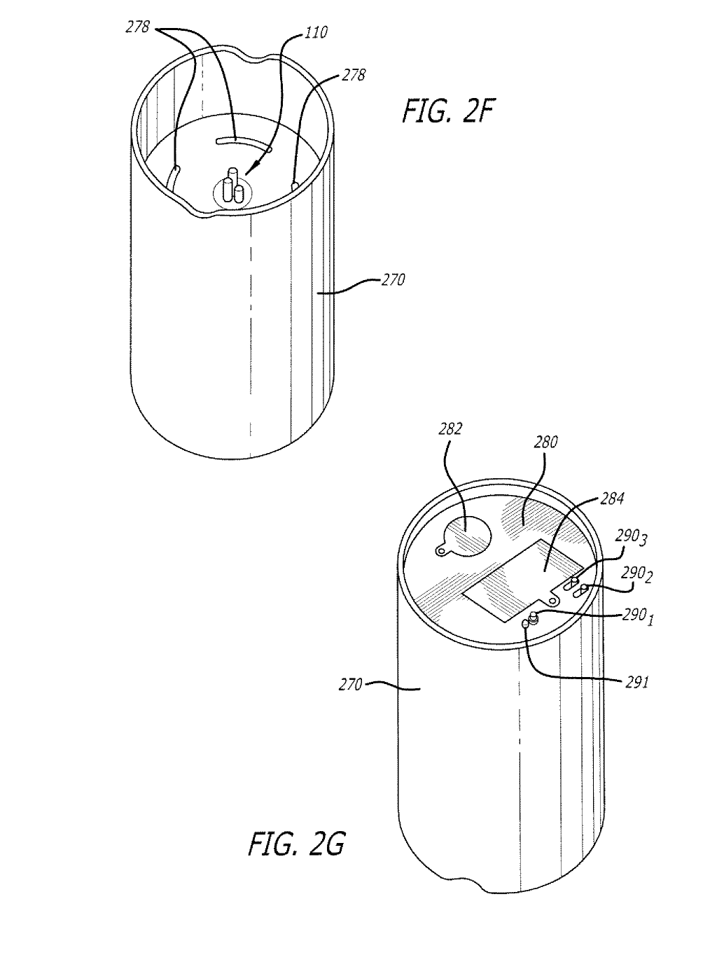

Referring now to FIG. 2A, a first exemplary embodiment of candle emulation device 100 of FIG. 1A is shown. Candle emulation device 100 is illustrated as one type of lighting fixture, namely a candle emulation device with a pillar or tapered candle housing 200 featuring translucent side walls 205 and 210 as well as an uncovered top opening 215. Light from light source 110, represented by multiple LEDs 220 for this embodiment, casts shadows replicating lighting from a candle frame. Translucent side walls 205 and 210 may form part of a wax (or plastic) scented or unscented candle shell having a smooth, textured drippy or otherwise aesthetically pleasing outer surface. For instance, the candle shell may be made of a polyresin for durability, and optionally the polyresin may be mixed with a scented material. Alternatively, translucent sidewalls 205 and 210 may be any other type of translucent material such as a natural or synthetic cloth, paper, plastic, glass, wax or other suitable material.

A connector 225 is configured as an interface for mating with a complementary base of light source 110 and thus, providing electrical connectivity between light source 110 and light source controller 120. Light source 110 is permanently coupled to connector 225, although it is contemplated that light source 110 may be removably connected.

Normally, the power source would be featured inside of pillar candle housing 200 and power supplied via an internal power source 130 within housing 200. However, it is contemplated that power may be supplied via a power line 227 which would be converted (e.g. regulated with conditional for components within candle emulation device 100).

According to one embodiment of the invention, fragrance-release mechanism (FRM) 150 is positioned within between sidewalls 205 and 210 to allow the fragrance to escape from housing 200. For instance, fragrance may escape through top opening 215 and/or one or more openings 207 in sidewalls 205 and/or 210. As an optional feature, the size of opening(s) 207 may be adjustable such as through rotation of a base 208 supporting translucent sidewalls 205 and 210 or by adjusting covers for one or more of openings 207. In general, a larger size for opening 207 provides greater air circulation and a greater amount of fragrance to be released. Fragrance-release mechanism 150 may be provided in a variety of form factors, such as a replaceable cartridge or aerosol canister for example.

Referring to FIG. 2B, a second exemplary embodiment of the candle emulation device of FIG. 1A is shown with fragrance-release mechanism 150 implemented within candle emulation device 100. Candle emulation device 100 is illustrated as a chandelier that comprises a frame 230 for supporting multiple light sources 235₁-235_{M} (M≧1), generally referred to as “light sources 235”. According to one embodiment, light sources 235 may be centrally controlled by light source controller 120 placed within an interior of frame 230 and routing power received from an external power source. Fragrance-release mechanism (FRM) 150 may be implemented at a selected location within frame 230.

However, according to another embodiment illustrated in FIG. 2C, each of the light sources 235 may be controlled in a decentralized fashion, where multiple light source controllers are placed within the housing of each corresponding light source 235₁, . . . , and 235_{M} or within frame 230 proximate to each corresponding light source 235₁, . . . , and 235_{M}. Fragrance-release mechanism (FRM) 150 may be removably inserted into one or more of these light sources (e.g., light source 235₁).

Referring to FIG. 2D, a fourth exemplary embodiment of candle emulation device 100 of FIG. 1A is shown with fragrance-release mechanism 150 implemented within candle emulation device 100. Configured as part of a single, removable light source 250, candle emulation device 100 comprises an Edison base 255 for rotational coupling to a lamp, desk light, sconce, or other lighting fixture. Candle emulation device 100 comprises light source controller 120, which is electrically coupled to both base 255 and incandescent bulb 220 and controls incandescent bulb 220 to provide a lighting effect that emulates a candle frame.

It is contemplated that base 255 may be a small, medium or large Edison base, bi-pin base, or any other commonly used light bulb base, which might be adapted for use with candle emulation device 100. Candle emulation device 100 includes fragrance-release mechanism 150 that, according to one embodiment of the invention, is a removable aerosol canister or cartridge that is inserted into a housing of candle emulation device 100. The housing would feature vents that allow fragrance to be emitted from an aerosol canister or from the cartridge, where the fragrance is provided from scented liquid or solid provided with the cartridge.

Referring now to FIGS. 2E-2G, a fifth exemplary embodiment of candle emulation device 100 of FIG. 1A is shown. According to this embodiment of the invention, candle emulation device 100 is illustrated as one type of lighting fixture, namely a pillar candle including an interior region 260 generally encased by a pillar or tapered candle housing 270. As shown, candle housing 270 is a candle shell including a generally concave, top opening 272 and translucent side walls 274 and 276. Side walls 274 and 276 are formed around a periphery of interior region 260.

Light from light source 110, represented by LEDs for this embodiment of the invention, casts shadows replicating lighting from a candle frame. Light source controller 120 is adapted to control the illumination from light source 110 and support member 288 is designed to support these components as a unit.

As shown in FIGS. 2E and 2F, top opening 272 includes apertures 278 that are positioned at selected areas within a top surface 279. Top surface 279 partially forms top opening 272 in order to enable air with fragrance to be released from interior region 260 and subsequently released from candle housing 270. The sizing of apertures 278 may be static or dynamic based on rotation of candle housing 270, adjustment of covers associated with the apertures, and the like. Hence, fragrance associated with scented material stored within cartridge 180, which is located within interior region 260, is allowed to escape via apertures 278 into the environment surrounding candle emulation device 100.

Referring back to FIGS. 2E and 2G, cartridge 180 is loaded into interior region 260 from a first opening 262 positioned on a bottom surface 280 of housing 270 and covered by a first panel 282. This first opening 262 is sized to receive one or more cartridges 180 featuring scented material having a particular fragrance. As shown, bottom surface 280 includes a second opening 264 covered by a second panel 284, which enables replacement of batteries 266 to provide power to light source 110 and a motorized fan 285 described below.

More specifically, interior region 260 comprises a battery compartment 281, cartridge 180 and motorized fan 285. Batteries 266 are loaded into battery compartment 281 through opening 264 located on bottom surface 280 of housing 270. Cartridge 180 featuring the scented material can be inserted and removed from housing 270 through opening 262 upon opening second panel 282. Of course, it is contemplated that an aerosol canister may be substituted in lieu of cartridge 180, provided an aerosol release mechanism such as a dispensing arm is implemented to release fragrance materials from the aerosol canister. Further discussion of other aerosol canister embodiments is described below.

In addition, interior region 260 partially houses one or more switches 290₁-290_{M} (M≧1) that selectively set the operational modes of at least light source 110 and/or motorized fan 285 and/or fragrance-release mechanism 150 (described below in detail). According to one embodiment of the invention, switches 290₁-290_{M} protrude through openings in top surface 279 and/or bottom surface 280 and are accessible by a user. Switches 290₁-290_{M} enable the user to place candle emulation device 100 into a plurality of operating modes where light source 110 may be OFF or ON and fan 285 may be OFF or ON. This enables candle emulation device 100 to operate exclusively as a lighting source, as a fragrance dispensing unit or as both.

It is contemplated that optional features may be added to candle emulation device 100. For instance, a timer (not shown) may be implemented within candle emulation device 100. In order to automatically control the activation and deactivation of fan 285 and/or illumination of light source 110. The timer may be implemented as a clock where activation and deactivation is controlled based on a clock time selected by the user. Alternatively, the timer may be implemented as a counter that activates fan 285 and/or light source 110 up to a selected count value or during certain sequences of count values or certain time periods. Based on the speed of the counter, this enables the user to select a period of time where fan 285 and/or light source 110 are activated. The counter may further be used to continuously cycle between activated and deactivated states of light source 110 and/or fan 285 according to the set count value. For instance, as an illustrative example, the counter may be programmed to cause the light source 110 and/or fan 285 to be powered and operational when the counter has a count value within a certain range. This could allow light source 110 and/or fan 285 to be activated at the same time periods during the day, week or month.

Moreover, candle emulation device 100 may be implemented with another optional feature, namely a light sensor (not shown). The light sensor is adapted to detect a change in lighting and, in response, turn ON or OFF light source 110.

It is contemplated that the timer and/or light sensor may be activated or deactivated by one of switches 290₁-290_{M} or may be preprogrammed as one of operational modes as described below.

More specifically, according to one embodiment of the invention, switches 290₁-290_{M} may be adapted to support different functionality. For instance, as an illustrative example, one switch 290 may be used to adjust the flickering rate of LEDs forming light source 110 while another switch 290₂ may be used to adjust the degree of illumination (light intensity) produced by the LEDs. One or both of these settings adjusts the lighting effects controlled by controller 120. As an example, the lighting effects may be controlled to emulate different environmental conditions (e.g., no wind where the flickering rate is low, windy where the flickering rate is higher than average and perhaps more random, romantic where the lighting has a lower degree of illumination, etc.). Another switch 290₃ may be used to adjust the rotational speed of fan 285 and/or release of fragrance. Although not shown, other switches may be adapted to activate or deactivate a light sensor or the timer as described below.

These switches 290₁-290_{M} may be implemented as toggle switches, push buttons, or the like. As an optional feature, as shown in FIG. 2G, an LED 291 may be positioned in close proximity to one or more of these switches in order to identify a selected setting or operating mode if switch 290₁ supports multiple settings or controls multiple operating modes of candle emulation device 100.

According to another embodiment of the invention, switches 290₁-290_{M} may be adapted where one switch (e.g., switch 290₁) is used to activate or deactivate candle emulation device 100 while the remainder of the switches (e.g., switch 290₂-290_{M}) are used to specify the operating mode of candle emulation device 100. This operating mode is based on various operational modes of components within candle emulation device 100.

More specifically, according to this embodiment of the invention, switch 290, may be used to turn ON/OFF candle emulation device 100, which will operate according to its preset functionality. For instance, when switch 290₁ is depressed, candle emulation device 100 is turned ON and operates in an operating mode corresponding to the settings preset for switches 290₂-290_{M}. Such settings may control one or more of the following functions as described herein: flickering rate; light intensity; fan rotational speed; timed activation of light source 110 and/or fan 285; or activation of an integrated light sensor.

According to yet another embodiment of the invention, switch 290, may be adapted to set the operating mode of candle emulation device 100 while the remainder of the switches (e.g., switch 290₂-290_{M}) are preset to select the functions of the operating mode. For instance, as an illustrative example, switch 290₂ may allow the user to preset a rotational speed of fan 285, where the preset could be as rudimentary as ON/OFF or could feature a plurality of different speeds (e.g., OFF, low, medium, high). In addition, switch 290₃ may allow the user to preset the operational mode of light source 110, where the preset could be as rudimentary as ON/OFF or could feature a plurality of different lighting effects (e.g., different levels of illumination and/or intensity). Some or all of these presets may be used to formulate different operating modes of candle emulation device 100.

As an illustrative example, different operating modes of candle emulation device 100 are shown in Table A. For this embodiment of the invention, LED 291 is placed proximate to switch 290, in order to identify the operating mode of candle emulation device 100, and thus, the operational modes of components within candle emulation device 100.

TABLE A

| Switch | | |
|---|---|---|
| mode | Fan Preset | Lighting Preset |
| 1 | OFF | OFF |
| 2 | ON (use preset) | OFF (ignore preset) |
| 3 | OFF (ignore preset) | ON (use preset) |
| 4 | ON (use preset) | ON (use preset) |

According to yet another embodiment of the invention, switch 290₁ may be adapted to set the operating mode of candle emulation device 100 with functionality that is preset and not modifiable by the user. For this embodiment of the invention, LED 291 is placed proximate to switch 290₁ and is used to identify the operating mode of candle emulation device 100 (and corresponding functions) as listed in Table B.

TABLE B

| Switch | Flickering | Lighting | | Light | |
|---|---|---|---|---|---|
| Mode | Rate | Intensity | Fan Speed | Sensor | Timer |
| 1 | OFF | OFF | OFF | OFF | OFF |
| 2 | ON-Preset | OFF | OFF | OFF | OFF |
| 3 | OFF | ON-Preset | OFF | OFF | OFF |
| 4 | OFF | OFF | ON-Preset | OFF | OFF |
| 5 | OFF | OFF | OFF | ON-Preset | OFF |
| 6 | OFF | OFF | OFF | OFF | ON-Preset |
| 7-32 | ON/OFF | ON/OFF | ON/OFF | ON/OFF | ON/OFF |

For illustration purposes, Table B features five (5) functions and thirty-two (32) possible combinations controlled by depression of switch 290₁. Combinations (7)-(32) are merely represented by ON/OFF designations for each function for simplicity. Some or all of these combinations may be utilized as operating modes of candle emulation device 100. As illustrative examples, the following options may be deployed as operating modes for candle emulation device 100 and are illustrated as Tables C-G.

TABLE C
Option A: Operating modes - OFF/Fan/Fan & Light

| | |
|---|---|
| Operating Mode 1 (OFF): | LED 291 is not illuminated; and |
| | Fan 285 and light source 110 are |
| | inactive |
| Operating Mode 2 (FAN ON): | LED 291 is illuminated (e.g., |
| Switch 290₁ depressed once | solid for a predetermined period of |
| to enter Mode 2 | time); and |
| | Fan 285 is active and operating |
| | either at fixed level (e.g., Low, |
| | Med or Hi), or preset by the user |
| | via a switch; and |
| | Light source 110 is inactive |
| Operating Mode 3 (Fan & | LED 291 illuminated differently |
| Light ON): | than in Mode 2 (e.g., flashes at a |
| Switch 290₁ depressed once | slow rate for a desired amount of |
| again to enter Mode 3 | time); |
| | Fan 285 is active and operating |
| | either at fixed level (e.g., Low, |
| | Med or Hi), or preset by the user |
| | via a switch; |
| | Light source 110 is active and |
| | flickering either at fixed rate |
| | (e.g., Calm, Medium, Windy), or |
| | preset by the user via a switch; |
| | Brightness of LEDs forming light |
| | source 110 operating either at |
| | fixed level (e.g., Full, Dim) or |
| | preset by the user via a switch. |

TABLE D
Option B: Operating modes - OFF /Fan/Fan & Light for first
time period (T1)/Fan & Light for second time period (T2)

| | |
|---|---|
| Operating Mode 1 (OFF): | LED 291 is not illuminated; and |
| | Fan 285 and light source 110 are |
| | inactive. |
| Operating Mode 2 (Fan ON): | LED 291 is illuminated (e.g., |
| Switch 290₁ depressed once | solid for a predetermined period of |
| to enter Mode 2 | time); |
| | Fan 285 is active and operating |
| | either at fixed level (e.g., Low, Med |
| | or Hi), or preset by the user via a |
| | switch; and |
| | Light source 110 is inactive |
| Operating Mode 3 (Fan & | LED 291 is illuminated differently |
| Light ON for time period | than in Mode 2 (e.g., flashes at a |
| T1): | slow rate for a desired amount of |
| Switch 290₁ depressed once | time); |
| again to enter Mode 3 | Fan 285 is active and operating |
| | either at fixed level (e.g.. Low, Med |
| | or Hi), or preset by the user via a |
| | switch; |
| | Light source 110 is active and |
| | flickering either at fixed rate |
| | (e.g., Calm, Medium, Windy), or |
| | preset by the user via a switch; |
| | Brightness of LEDs forming light |
| | source 110 operating either at fixed |
| | level (e.g., Full, Dim) or preset by |
| | the user via a switch; and |
| | After a time period (T1), the |
| | light source 110 becomes inactive, |
| | but fan 285 remains active. |
| Operating Mode 4 (Fan & | LED 291 illuminated differently |
| Light ON for time period | than in Mode 3 (e.g., flashes at a |
| T2): | faster rate than in Mode 3); |
| Switch 290₁ depressed once | Fan 285 is active and operating |
| again to enter Mode 4 | either at fixed level (e.g., Low, Med |
| | or Hi), or preset by the user via a |
| | switch; |
| | Light source 110 is active and |
| | flickering either at fixed rate |
| | (e.g., Calm, Medium, Windy), or |
| | preset by the user via a switch; |
| | Brightness of LEDs forming light |
| | source 110 operating either at fixed |
| | level (e.g., Full, or Dim) or preset |
| | by the user via a switch; and |
| | After a time period (T2), light |
| | source 110 becomes inactive, but fan |
| | 285 remains active. |

TABLE E
Option C: Operating modes - OFF/Fan/Fan & Light with
light sensor activation for time period (T1)/Fan & Light
with light sensor activation for time period (T2)

| | |
|---|---|
| Operating Mode 1 (OFF): | LED 291 is not illuminated; |
| | and |
| | Fan 285 and light source 110 |
| | are inactive |
| Operating Mode 2 (Fan ON): | LED 291 is illuminated |
| Switch 290₁ depressed once | (e.g., solid for a |
| to enter Mode 2 | predetermined period of time); |
| | Fan 285 is active and |
| | operating either at fixed level |
| | (e.g., Low, Med or Hi), or |
| | preset by the user via a |
| | switch; and |
| | Light source 110 is inactive |
| Operating Mode 3 (Fan & | LED 291 illuminated |
| Light ON for T1): | differently than in Mode 2 |
| Switch 290₁ depressed once | (e.g., flashes at a slow rate |
| again to enter Mode 3 | for a desired amount of time); |
| | Fan 285 is active and |
| | operating either at fixed level |
| | (e.g., Low, Med or Hi), or |
| | preset by the user via a |
| | switch; |
| | Light source 110 is active |
| | for a predetermined number of |
| | hours (T1) after light sensor |
| | detects insufficient lighting. |
| | When active, light source 110 |
| | is operational and flickering |
| | either at fixed rate (e.g., |
| | Calm, Medium, Windy), or preset |
| | by the user via a switch; |
| | Brightness of LEDs forming |
| | light source 110 operating |
| | either at fixed level (e.g., |
| | Full or Dim) or preset by the |
| | user via a switch; and |
| | After a time period (T1), |
| | the light source 110 becomes |
| | inactive, but fan 285 remains |
| | active. |
| Operating Mode 4 (Fan & | LED 291 illuminated |
| Light ON for T2): | differently than in Mode 3 |
| Switch 290₁ depressed once | (e.g., flashes at a different |
| again to enter Mode 4 | rate than in Mode 3); |
| | Fan 285 is active and |
| | operating either at fixed level |
| | (e.g., Low, Med or Hi), or |
| | preset by the user via a |
| | switch; |
| | Light source 110 is active |
| | for a predetermined number of |
| | hours (T2; T2 > T1) after light |
| | sensor detects insufficient |
| | lighting. When active, light |
| | source 110 is operational and |
| | flickering either at fixed rate |
| | (e.g., Calm, Medium, Windy), or |
| | preset by the user via a |
| | switch; |
| | Brightness of LEDs forming |
| | light source 110 operating |
| | either at fixed level (e.g., |
| | Full or Dim) or preset by the |
| | user via a switch; and |
| | After a time period (T2), the |
| | light source 110 becomes |
| | inactive, but fan 285 remains |
| | active. |

TABLE F
Option D: Operating modes - OFF/Fan/Fan & Light activation with
timer for T1/Fan & Light with light sensor activation for T2

| | |
|---|---|
| Operating Mode 1 (OFF): | LED 291 is not illuminated; |
| | Fan 285 and light source 110 |
| | are inactive |
| Operating Mode 2 (Fan ON): | LED 291 is illuminated |
| Switch 290₁ depressed once | (e.g., solid for a |
| to enter Mode 2 | predetermined period of time) |
| | Fan 285 is active and |
| | operating either at fixed level |
| | (e.g., Low, Med or Hi), or |
| | preset by the user via a |
| | switch; and |
| | Light source 110 is not |
| | active. |
| Operating Mode 3 (Fan & | LED 291 illuminated |
| Light ON for T1): | differently than in Mode 2 |
| Switch 290₁ depressed once | (e.g., flashes at a slow rate |
| again to enter Mode 3 | for a desired amount of time); |
| | Fan 285 is active and |
| | operating either at fixed level |
| | (e.g., Low, Med or Hi), or |
| | preset by the user via a |
| | switch; |
| | Light source 110 is active |
| | for a predetermined time period |
| | (T1), When active, light |
| | source 110 is operational and |
| | flickering either at fixed rate |
| | (e.g., Calm, Medium, Windy), or |
| | preset by the user via a |
| | switch; |
| | Brightness of LEDs forming |
| | light source 110 operate either |
| | at fixed level (e.g., Full or |
| | Dim) or preset by the user via |
| | a switch; and |
| | After a time period (T1), |
| | the light source 110 becomes |
| | inactive, but fan 285 remains |
| | active. |
| Operating Mode 4 (Fan & | LED 291 illuminated |
| Light ON with Light Sensor | differently than in Mode 3 |
| for T2): | (e.g., flashes at a different |
| Switch 290₁ depressed once | rate than in Mode 3); |
| again to enter Mode 4 | Fan 285 is active and |
| | operating either at fixed level |
| | (e.g., Low, Med or Hi), or |
| | preset by the user via a |
| | switch; |
| | Light source 110 is active |
| | for a predetermined time (T2) |
| | after light sensor detects |
| | insufficient lighting. When |
| | active, light source 110 is |
| | operational and flickering |
| | either at fixed rate (e.g., |
| | Calm, Medium, Windy), or preset |
| | by the user via a switch; |
| | Brightness of LEDs forming |
| | light source 110 operate either |
| | at fixed level (e.g., Full or |
| | Dim) or preset by the user via |
| | a switch; and |
| | After a time period (T2), |
| | the light source 110 becomes |
| | inactive, but fan, 285 remains |
| | active. |

TABLE G
Option E: Operating modes - OFF/Fan/Fan & Light ON/
Fan & Light with light sensor activation for T1

| | |
|---|---|
| Operating Mode 1 (OFF) | LED 291 is not illuminated |
| | Fan 285 and light source 110 |
| | are inactive |
| Operating Mode 2 (Fan ON): | LED 291 is illuminated |
| Switch 290₁ depressed once | (e.g., solid for a |
| to enter Mode 2 | predetermined period of time) |
| | Fan 285 is active and |
| | operating either at fixed level |
| | (e.g., Low, Med or Hi), or |
| | preset by the user via a |
| | switch; and |
| | Light source 110 is inactive |
| Operating Mode 3 (Fan & | LED 291 illuminated |
| Light ON): | differently than in Mode 2 |
| Switch 290₁ depressed once | (e.g., flashes at a slow rate |
| again to enter Mode 3 | for a desired amount of time); |
| | Fan 285 operational and |
| | operating either at fixed level |
| | (either Low, Med or Hi), or |
| | preset by the user via a |
| | switch; |
| | Light source 110 is active |
| | and flickering either at fixed |
| | rate (e.g., Calm, Medium, |
| | Windy), or preset by the user |
| | via a switch; |
| | Brightness of LEDs forming |
| | light source 110 operating |
| | either at fixed level (e.g., |
| | Full or Dim) or preset by the |
| | user via a switch. |
| Operating Mode 4 (Fan & | LED 291 illuminated |
| Light ON for T1): | differently than in Mode 3 |
| Switch 290₁ depressed once | (e.g., flashes at a faster rate |
| again to enter Mode 4 | for a desired amount of time); |
| | Fan 285 is active and |
| | operating either at fixed level |
| | (e.g., Low, Med or Hi), or |
| | preset by the user via a |
| | switch; |
| | Light source 110 is active |
| | for a predetermined time (T1). |
| | When active, light source |
| | flickering either at fixed rate |
| | (e.g., Calm, Medium, Windy), or |
| | preset by the user via a |
| | switch; |
| | Brightness of LEDs forming |
| | light source 110 operating |
| | either at fixed level (e.g., |
| | Full or Dim) or preset by the |
| | user via a switch; and |
| | After a time period (T1), |
| | the light source 110 becomes |
| | inactive, but fan 285 remains |
| | active. |

As shown in FIG. 2E, it is contemplated that some or all of switches 290₁-290_{M} may be positioned on top surface 279 so that a user can control the operating mode of candle emulation device 110 without having to pick up device 110 and access bottom surface 280. As an illustrative example, switch 290₁ and LED 291 are shown positioned on top surface 279 while an optional switch 290₂ is positioned protruding from bottom surface 280.

Upon powering motorized fan 285, a greater amount of fragrance can be routed from interior region 260 and exit apertures 278 of concave top opening 272. Therefore, fragrance dispensing can be turned OFF (or at least greatly mitigated) when fan 285 is turned OFF. It is contemplated that one of the switches 290 may be able to control the rotational speed of fan 285 (high, medium, low) that will also adjust the amount of fragrance dispensed since greater airflow over wick 185 causes increased evaporation (and dispensation) of the scented liquid. Alternatively, a clock or counter may be used to control the operations of fan 285 such as periodic or non-periodic rotation (e.g., throttled rotation).

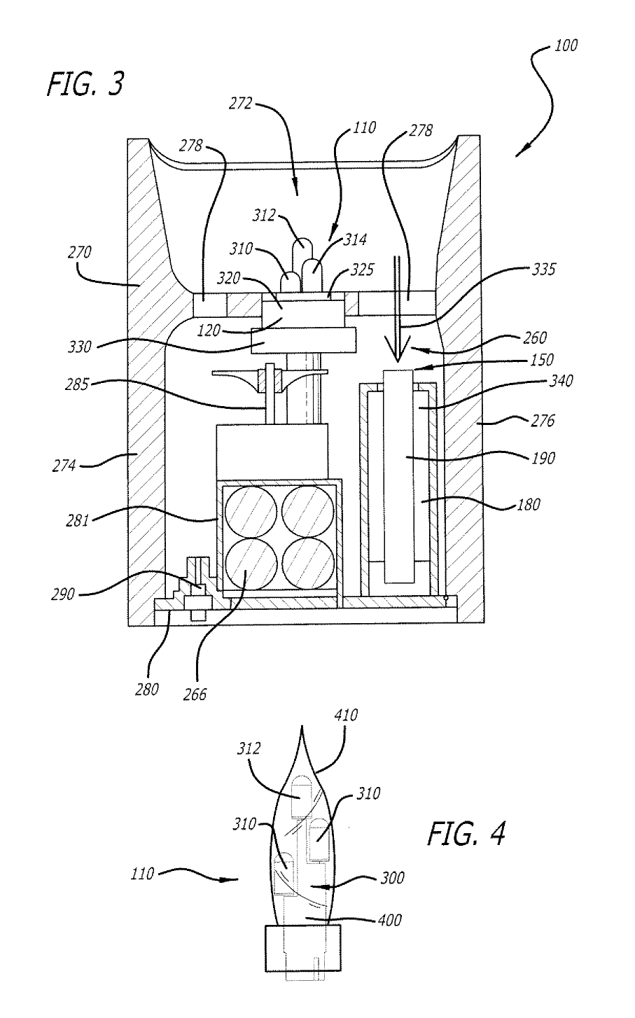

Referring now to FIG. 3, a cross-sectional view of a sixth exemplary embodiment of candle emulation device 100 with fragrance-release mechanism 150 is shown. According to this embodiment of the invention, contained within housing 105, light source 110 comprises an assembly 300 that includes three lighting elements such as LEDs 310, 312 and 314. Of course, in lieu of LEDs, it is contemplated that light source 110 may be implemented with more or less than three lighting elements and other types of lighting elements such as incandescent bulbs may be used. For instance, the incandescent bulbs may range from 55-100 milliamperes (mA) to accommodate low-power applications.

Besides the above-described lighting elements, assembly 300 further comprises a connector component 325 that provides an electrical interface with light source controller 120. For instance, connector component 325 may be an interconnect (e.g., lead lines) as described below or even a separate, auxiliary printed circuit board (PCB) 320 that is adapted to operate as light source controller 120.

According to one embodiment of the invention, lighting elements 310, 314 and 312 are positioned at different heights from a surface of the bottom surface of top opening 272 or from a top surface of PCB. Connector component 325 and light source controller 120 are supported by a support member 330. According to another embodiment, two or more of lighting elements 310, 312 and 314 may be positioned at the same height.

Of course, assembly 300 may have other embodiments. For instance, it is contemplated that lighting elements 310, 312 and 314 could be soldered directly to a PCB of light source controller 120 in either a vertical or horizontal orientation or connected via wires of some length.

As another example, assembly 300 may be adapted with a plurality of electrical lead lines each including a LED coupled at one end and the other end coupled to light source controller 120. The lead lines may be protected by a sleeve housing, which surrounds and covers at least a portion of the surface of the lead lines. No PCB 320 would be required.

It is further contemplated that an effect could be created using any number of light sources, especially when placed in at different heights or in different planes or when using lighting sources of different colors.

In addition to the light source 110 described above, fragrance-release mechanism 150 comprises motorized fan 285 that is powered by a portable power source and either cartridge 180 to contain a liquid with fragrance or an aerosol canister (not shown). Cartridge 180 is top-loading as illustrated by arrow 335 for insertion within interior region 260 with a first end 340 of cartridge 180 that is open to allow a selected fragrance to be released through apertures 278 in candle housing 270.

Referring to FIG. 4, an alternative embodiment of light source 110 for candle emulation device 100 is shown. In this embodiment of the invention, assembly 300 comprises a PCB 400 that is controlled by light source controller 120 to replicate a lighting pattern to represent a flickering candle. Assembly 300 is encased, or otherwise covered in a translucent material 410 to protect it from moisture and mechanical damage. As an example, material 410 is Dow Sylgard® 184/182 Silicone. The silicone is molded so that it not only protects lighting elements 310, 312 and 314 from moisture and mechanical damage, but the flexible silicone material also provides a seal with whatever electronics housing it is plugged into.

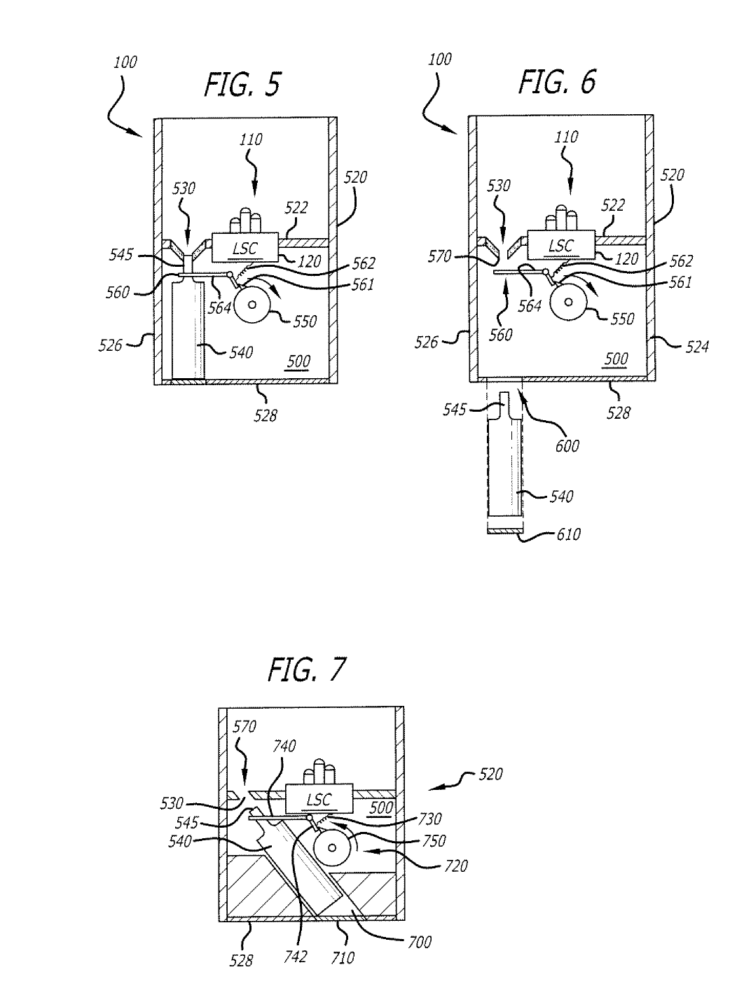

Referring now to FIGS. 5-7, a seventh exemplary embodiment of candle emulation device 100 of FIG. 1A is shown. According to this embodiment of the invention, candle emulation device 100 is illustrated as a type of lighting fixture, such as a pillar candle including an interior region 500 generally encased by a candle housing 520 for example. As shown, candle housing 520 is a candle shell including translucent side walls 524 and 526 and a recessed, top surface 522 that is positioned below the top edges of side walls 524 and 526. Side walls 524 and 526 are formed around a periphery of interior region 500.

Light from light source 110, represented by LEDs for this embodiment of the invention, is controlled to replicate lighting from a candle frame. Light source controller (LSC) 120 is adapted to control the illumination from light source 110.

As further shown in FIGS. 5 and 6, top surface 522 includes one or more apertures 530 positioned at selected areas. Aperture(s) 530 provide an outlet for the release of fragrance such as aerosolized particles with fragrance that are stored within an aerosol canister 540 that is placed within interior region 500 below top surface 522.

For this embodiment of the invention, the release of the aerosolized particles with fragrance is controlled by the collective operations of a motor 550 and a dispensing control element 560, although other mechanisms may be used. Motor 550 is adapted to control the positioning of dispensing control element 560 which, depending on its position, allows for the release of aerosolized particles from a nozzle 545 of aerosol canister 540.

As illustrative examples, when nozzle 545 is positioned below top surface 522, aerosolized particles with fragrance are released from nozzle 545 and propagate through apertures) 530. According to one embodiment, a pathway 570 operates as a conduit to direct the aerosolized particles to project from apertures) 530. The configuration of pathway 570 may be any design choice, such as a tapered configuration as shown in FIGS. 5-6 although a non-tapered configuration may be utilized. Of course, it is contemplated that pathway 570 would not be necessary where nozzle 545 extends through aperture 530 and is positioned above top surface 522 or nozzle 545 is flush with top surface 522.

More specifically, as shown in this illustrative embodiment, dispensing control element 560 may be implemented as a spring-biased dispensing arm, namely a spring 562 that is coupled to and assists in controlling the positioning of a dispensing arm 564. Herein, according to this embodiment of the invention, spring 562 is coupled to a pivotal end 561 of dispensing arm 564 and motor 550 applies a directional force to pivotal end 561.

This directional force controls the pivoting state of dispensing arm 564; namely, the application of a force to the pivotal end 561 immediately followed by cessation of the force causes dispensing arm 564 to be lowered, and thereafter, raised. The lowering of dispensing arm 564 opens nozzle 545 of aerosol canister 540 and releases the aerosolized particles with fragrance. The amount of aerosol contents released can be based, at least in part, on the elasticity of spring 562 (i.e., amount of force exerted by spring 562 and the quickness in returning to its resting state where nozzle 545 is closed). Alternative, force may be applied through to nozzle 545 by releasing dispensing arm 562 and applying a downward force to the nozzle 545 as described below.

The aerosolized particles with fragrance are released through pathway 570 to apertures 530 for release into the surrounding environment. The sizing of apertures 530 may be static or may be dynamic to provide another mechanism for adjusting the amount of fragrance released.

It is contemplated that the release of the aerosolized particles with fragrance from aerosol canister 540 may be user activated through depression of a switch or button that, in turn, causes nozzle 545 to be opened for a short duration. Alternatively, it is further contemplated that the release of the aerosolized particles with fragrance from aerosol canister 540 may be time-based under control of a counter, a timer or other time-based control logic.

Referring to FIG. 6, aerosol canister 540 is loaded into interior region 500 from a first opening 600 positioned on a bottom surface 528 of housing 520 and covered by a panel 610. This first opening 600 is sized to receive one or more aerosol canisters 540. According to this embodiment of the invention, canister 540 is removable to allow for canisters having different fragrances to be substituted as desired or for empty canisters to be replaced.

Alternatively, as shown in FIG. 7, aerosol canister 540 is loaded at an angle into interior region 500 from an angular first opening 700 positioned on bottom surface 528 of housing 520 and covered by a panel 710. This first opening 700 is sized to receive one or more aerosol canisters 540

According to this embodiment of the invention, dispensing control element 720 may be implemented as a spring-biased dispensing arm, namely a spring 730 that is coupled to and assists in controlling the positioning of a dispensing arm 740. Herein, according to this embodiment of the invention, spring 730 is coupled to a pivotal end 742 of dispensing arm 740 and motor 750 applies a directional force to pivotal end 742. This directional force controls the pivoting state of dispensing arm 740, namely, the application of a force to the pivotal end 742 immediately followed by cessation of the force causes dispensing arm 740 to be raised, and quickly lowered to open nozzle 545.

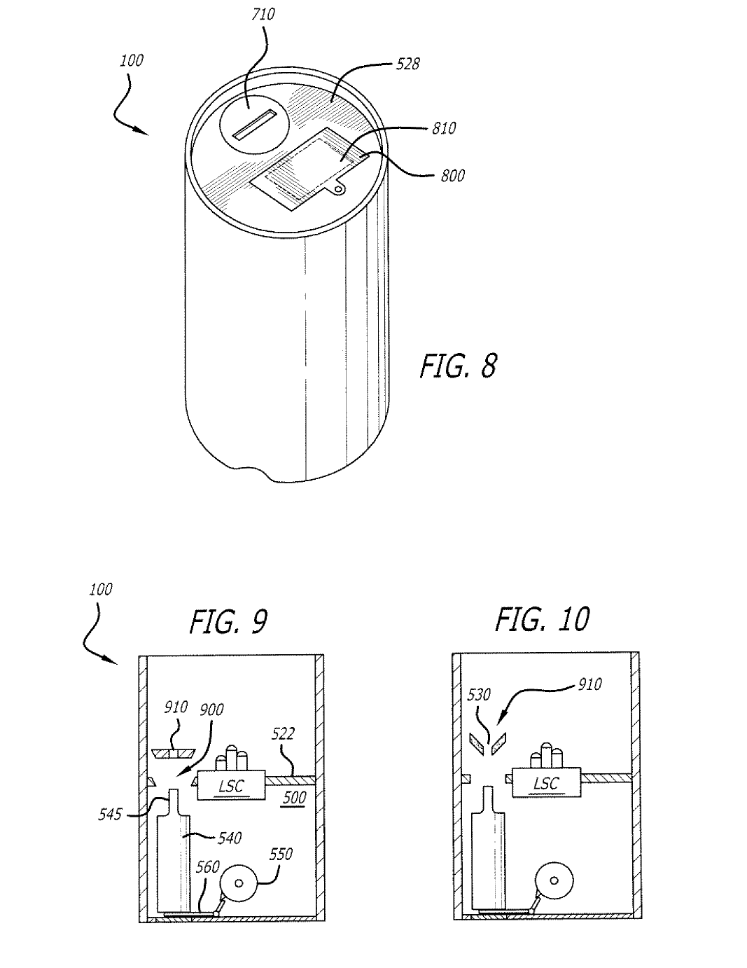

As shown in FIG. 8, bottom surface 528 of candle emulation device 100 further includes a second opening 800 covered by a second panel 810, which enables replacement of batteries to provide power to motor 550 of FIGS. 5-7 that, in turn, provides a suitable power to light source 110 of FIGS. 5-7 and/or a motorized fan as described above as well as controls the release of fragrance from aerosol canister 540 of FIGS. 5-7.

Referring now to FIG. 9, it is contemplated that aerosol canister 540 may be removable and top-loaded, namely loaded from a top of candle emulation device 100. More specifically, an aperture 900 may be sized to enable aerosol canister 540 to be placed within interior region 500 below top surface 522. Dispensing control element 560 is disengaged from aerosol canister 540 for removal and re-engaged with the replacement aerosol canister 540.

A cover 910 is shaped to hide aerosol canister 540 so that it is not highly visible and to assist in applying a downward force to open nozzle 545 upon raising aerosol canister 540 toward cover 910 by motorized dispensing control element 550 and 560. For instance, cover 910 may be securely attached to top surface 522 of housing 520 by threads (e.g., rotated into place) along a diameter of aperture 900 or other securing techniques. Cover 910 may be tapered and include aperture 530 from which aerosolized particles are released as illustrated in FIG. 10. Of course, it is contemplated that cover 910 may be sized to fill the entire inner diameter of housing 520. Hence, cover 910 could be used as the top surface of the housing, provided that cover 910 is supported above the bottom surface of the housing (e.g., bottom surface 528 of housing 520).

While the invention has been described in terms of several embodiments, the invention should not be limited to only those embodiments described, but can be practiced with modification and alteration within the spirit and scope of the appended claims. For instance, the mechanism for controlling the release of fragrance from the aerosol canister may be based on another mechanical technique or may be positioned anywhere in the interior of the candle shell such as near the top surface or the bottom wall. Hence, the description is thus to be regarded as illustrative instead of limiting.

What is claimed is:

1. A candle emulation device comprising;
a candle housing including sidewalls and a recessed top surface that creates an enclosed first area and an open second area;
a light source;
a light source controller positioned within the enclosed first area of the candle housing and coupled to the light source, the light source controller to control the light source in order to produce a lighting effect that emulates lighting from a candle frame; and
a fragrance-release mechanism including an aerosol canister positioned within the enclosed first area and controlled to release a fragrance into air surrounding the candle emulation device.

2. The candle emulation device of claim 1, wherein the light source includes one or more light emitting diodes controlled by the light source controller.

3. The candle emulation device of claim 1, wherein the aerosol canister of the fragrance-release mechanism is removable.

4. The candle emulation device of claim 3, wherein the aerosol canister is inserted from a bottom of the candle housing.

5. The candle emulation device of claim 4, wherein the fragrance-release mechanism includes a motor activated by a timer to cause the aerosolized particles with fragrance to be released from the aerosol canister through an aperture within the top surface of the candle housing.

6. The candle emulation device of claim 4, wherein the fragrance-release mechanism includes a motor activated by either depressing a button or moving a switch extending from the candle housing in order to cause the aerosolized particles with fragrance to be released from the aerosol canister through an aperture within the top surface of the candle housing.

7. The candle emulation device of claim 1, wherein the fragrance-release mechanism is activated by depressing a button or moving a switch extending from the top surface of the candle housing in order to control at least one of a production of the lighting effect and a release of the aerosolized particles with fragrance from the aerosol canister.

8. The candle emulation device of claim 1, wherein the fragrance-release mechanism is activated by a timer to cause the aerosolized particles with fragrance to be released from the aerosol canister.

9. The candle emulation device of claim 3, wherein the aerosol canister is inserted into the enclosed second area from the open first area with a cover that is attached to the top surface, the cover having an aperture through which the fragrance is released.

10. A candle emulation device comprising:
a candle housing including a bottom surface, sidewalls and a recessed top surface that creates a cavity between the sidewalls and the top surface and creates an enclosed interior area between the bottom surface, sidewalls and the top surface, the top surface including an aperture;
a light source;
a light source controller implemented within the candle housing and coupled to the light source, the light source controller to control the light source in order to produce a first lighting effect and a second lighting effect different than the first lighting effect, both the first lighting effect and the second lighting effect emulate lighting from a candle frame; and
a fragrance-release mechanism positioned within the enclosed interior area and is adapted to release aerosolized particles with fragrance through the aperture.

11. The candle emulation device of claim 10, wherein the fragrance-release mechanism is activated by a timer to cause the aerosolized particles with fragrance to be released from an aerosol canister.

12. The candle emulation device of claim 11, wherein the fragrance-release mechanism is adapted to be activated by a user and cause the aerosolized particles with fragrance to be released from the aerosol canister and into ambient air surrounding the candle emulation device.

13. The candle emulation device of claim 10, wherein the fragrance-release mechanism includes a motor to assist in releasing the aerosolized particles with fragrance into ambient air surrounding the candle emulation device.

14. The candle emulation device of claim 10, wherein the aerosol canister is inserted into the cavity for placement within the enclosed interior with a cover that is attached to the recessed top surface and has an aperture through which the fragrance is released.

15. A candle emulation device comprising:
a candle housing including a bottom surface, sidewalls, a cavity formed by the sidewalls and a recessed top surface, and an enclosed interior formed by the sidewalls and the bottom surface;
a light source;
a light source controller implemented within the candle housing and coupled to the light source, the light source controller to control the light source in order to produce a plurality of lighting effects, wherein at least a first lighting effect emulates lighting from a candle frame; and
a fragrance-release mechanism positioned within an enclosed interior and is adapted to release aerosolized particles with fragrance.

16. The candle emulation device of claim 15, wherein the light source includes one or more light emitting diodes controlled by the light source controller positioned within the enclosed interior of the candle housing.

17. The candle emulation device of claim 16, wherein the aerosol canister of the fragrance-release mechanism is top-loaded.

18. The candle emulation device of claim 15, wherein the fragrance-release mechanism includes a timer to automatically cause a release of the aerosolized particles with fragrance from the aerosol canister.

19. The candle emulation device of claim 15, wherein the fragrance-release mechanism is activated by either depressing a button or moving a switch extending from the recessed top surface of the candle housing in order to cause the aerosolized particles with fragrance to be released from the aerosol canister.

20. The candle emulation device of claim 17, wherein the aerosol canister is inserted into the cavity for placed within the enclosed interior and a cover that is attached to the top surface and includes an aperture through which the fragrance is released.
